(19) United States
(12) Patent Application Publication
(10) Pub. No.: US 2016/0326744 A1
(43) Pub. Date: Nov. 10, 2016

(54) LAYERED BUILDING BOARD FOR INSIDE AND OUTSIDE

(71) Applicant: Kronoplus Technical AG, Niederteufen (CH)

(72) Inventors: Dieter DÖHRING, Niederteufen (CH); Manfred BIEHLER, Ludwigshafen (DE)

(21) Appl. No.: 15/109,491

(22) PCT Filed: Jan. 14, 2014
(86) PCT No.: PCT/EP2014/000073

§ 371 Date: Jul. 1, 2016

(51) Int. Cl. E04C 2/24; B32B 7/12; E04F 13/08; B32B 21/06; E04C 2/20; B32B 27/10; B32B 21/02

(52) U.S. Cl. CPC E04C 2/24; B32B 27/10; B32B 7/12; B32B 21/02; B32B 21/06; E04C 2/20; E04F 13/0871; E04F 13/0866; E04F 13/0894; B32B 2419/00; B32B 2260/028; B32B 2260/046; B32B 2307/712; B32B 2451/00

(57) ABSTRACT

A layered building board for inside and outside is described. The building board includes a core layer (20) and a melamine resin impregnated paper (21) arranged thereon. In order to improve the adhesion of further layers, an adhesion layer (30) comprising polyurethane and acrylate is provided on the paper.

### CROSS REFERENCES TO RELATED APPLICATIONS

This application is a US national stage application from PCT/EP2014/000073 filed Jan. 14, 2014.

### FIELD

The present invention relates to a layered building board for inside and outside, a board for manufacturing such a building board, as well as a method for manufacturing such a building board.

### BACKGROUND

Building boards have several applications for the inside- and outside-construction of buildings. They serve for instance as facade boards for the optical covering of building facades for aesthetical reasons and/or for protecting the buildings stock from atmospheric influences.

The use of fiber cement as facade board is widespread. Fiber cement is the umbrella term for composite materials made of cement and tension proved fibers as they are distributed for instance under the tradename Eternit. Furthermore, laminate boards are widely used (also as high pressure laminate (HPL)), which are based on a core of multiple layers of Kraft paper impregnated with phenolic resins. A décor paper is applied on the front and on the rear side of said core which is usually impregnated with a melamine resin. Core layers and décor layers are pressed in high-pressure presses at increased temperature and a specific pressing pressure between 70-100 bars. However, a large amount of the used decors do not have sufficient atmospheric protection. Thus, color changes occur over time due to UV radiation from the sun, in particular caused by an attacking on the color pigments. To achieve sufficient stability in color and thus longevity of the facade boards, different solutions have been established. A known method comprises an additional application of a particular poly-methyl-methacrylate foil on the décor paper and to press them. This PMMA foil consists of UV filters with which up to 99% of the UV radiation can be absorbed. Such PMMA foils are for instance known under the tradename Korad foil. The disadvantage of said foils is that they have to be pressed with a particular silicon release paper. This leads to relatively high glossing surfaces, which is optically undesired. Furthermore, the PMMA foil is relatively soft, so that such boards comprise an insufficient scratching resistance. Moreover, the surfaces are difficult to clean, in particular the removal of graffiti is difficult.

To avoid these disadvantages, certain methods have been developed. In one method, the décor layers are for instance impregnated with a melamine resin and dried in a first step. In a second step, these impregnated decors are passed through a lacquer channel, where at a particular thermosetting acrylate resin is applied one sided, which already contains the UV filtering system. Subsequently, the pressing takes place, as described above. In a further method, the core of phenolic resin is combined with electron beam lacquered décor foils.

Building boards, which are suitable for manufacturing floors, are known for instance from WO 2007/042258 A1. Herein, a method for a direct coating of a wood based material board is described, wherein a relatively thick protection layer of a plastic material is applied on the surface of the board in a single coating step. The used plastic material is thereby a polymerizable acrylate system, which cures by polymerization. The polymerization is thereby triggered by radiation so that a complete conversion occurs through the thickness of the applied layer.

In WO 2008/061791 A1 of the same applicant, a further development of the known prior art is described. The quintessence of the improvement of this publication is that at least two liquid polymer layers are applied on the surface of a board wet-in-wet so that a partial mixing of the coating materials takes place. These two wet-in-wet applied layers are then cured together, where at the cured resulting coating comprises a hardness gradient due to the partial mixing, wherein the hardness of the coating decreases with increasing depth, as seen from the surface of the resulting coating.

The present invention has therefore the task to improve the known prior art and in particular provide a layered building board for inside and outside at which the layers comprise a very good adhesion and at which a décor print can be preferably introduced in the intermediate layers directly without a paper carrier. Further, it is desirable that the surfaces have improved characteristics, like in particular an improved scratch and abrasion resistance and which are at the same time easy to clean. The disadvantages, as set out in the prior art, can be eliminated by particular chemical structure characteristics, according to the invention. These and other tasks, which will be mentioned during reading of the following description or can be recognized from a person skilled in the art will be solved by a layered building board according to the claims herein.

### SUMMARY

The difficulties and drawbacks associated with previous approaches are addressed in the present subject matter as follows.

In one aspect, the present invention provides a layered building board for inside and outside. The layered building board comprises a core having a front side and a rear side. The layered building board also comprises an amino resin impregnated paper arranged thereon. And, the layered building board also comprises an adhesion layer comprising polyurethane and acrylate arranged on the paper.

In another aspect, the present invention provides a layered board for manufacturing a building board comprising a core having a front side and a rear side. The layered board also comprises an amino resin impregnated paper arranged thereon. The layered board also comprises an adhesion layer of a mixture of isocyanate and (meth)acrylate arranged on the paper. And, the layered board also comprises an acrylate layer arranged thereon.

In yet another aspect, the present invention provides a method for manufacturing a layered building board for inside and outside. The method comprises a step a. of providing a core with a front side and a rear side. The method also comprises a step b. of providing an amino resin impregnated paper on the front and/or rear side of the core. The method also comprises a step c. of providing a mixture of isocyanate and (meth)acrylate on the paper thereafter. The method also comprises a step d. of applying an acrylate layer after step c. And, the method also comprises a step e. of applying the layers applied in steps c. and d., together.

As will be realized, the subject matter described herein is capable of other and different embodiments and its several details are capable of modifications in various respects, all without departing from the claimed subject matter. Accordingly, the drawings and description are to be regarded as illustrative and not restrictive.

### BRIEF DESCRIPTION OF THE DRAWINGS

In the following the present invention is described in greater detail with reference to the enclosed figures.

FIG. 1 shows a schematic structure of a layered building board with a core and outside layers including polycondensed thermoset resinated papers according to the invention.

FIG. 2 shows a layered board, wherein the adhesion layer is not yet completely converted according to the invention.

FIG. 3 shows a layered building board, according to the invention.

FIG. 4 shows another embodiment of a layered building board, according to the invention.

FIG. 5 shows an exemplary schematically depicted device for manufacturing of boards according to the invention respectively for carrying out the method according to the invention.

### DETAILED DESCRIPTION OF THE EMBODIMENTS

According to the invention, a layered building board is provided, which is suitable for the inside and outside. The board comprises a core on which at least one paper, which is impregnated with a thermoset resin and in particular an amino resin is arranged. Such papers comprise excellent mechanical characteristics after curing of the resin, however, the surfaces can be poorly coated, since most of the established materials and in particular acrylates only poorly adhere on these thermoset resin surfaces, in particular when they are based on melamine resins. For the solution of this problem the invention provides a particular adhesion layer, wherein the layer is based on a mixture of isocyanates and (meth)acrylates (methacrylates, acrylates and mixtures of both linking groups are herein understood as (meth)acrylates) and, where required, catalysts and/or initiators, as well as lacquer specific additives. This mixture is applied on the cured board surface, for instance rolled on, sprayed on or cast on and preferably partially cured by means of high energy radiation. This adhesion layer can be applied in one process step, however one can also sequentially apply multiple thin layers of the same or similar mixtures, wherein the intermediate layers are gelled by means of high energy radiation, preferably UV radiation. In the following, this layer is generally designated as adhesion layer. Preferably another (meth)acrylate layer, which preferably has a thickness of more than 20 μm, more preferably of more than 30 μm and most preferred of more than 40 μm, is arranged on said adhesion layer directly after the partial curing.

The adhesion layer and the preferably applied further (meth)acrylate layer are then cured together in a further step, for instance by means of UV radiation. In a significantly slower occurring parallel reaction the isocyanate is converted inter alia with the hydroxyl groups of the acrylate under the formation of urethane linkages. This reaction is completed after approximately 10 days so that the adhesion layer contains polyurethane and acrylate after this period. The isocyanate is then completely converted and no longer detectable in the product. It has been shown that (meth)acrylate layers adhere very good on the melamine resin surface of the building board with the help of this adhesion layer so that for instance the requirements of EN438 for outside applications of such produced building boards are fully met.

The adhesion layer is preferably applied in a thickness of 10 to 100 μm, more preferably of 10 to 80 μm, even more preferably of 15 to 70 μm and most preferred of 20 to 60 μm. After the complete reaction of the isocyanate with the reactive groups of the binder matrix, in particular the hydroxyl groups of the (meth)acrylate, the adhesion layer preferably consists essentially of a polymer mixture of polyurethane and poly(meth)acrylate. A complete reaction of the isocyanate is also secured in that potentially not yet converted groups of the isocyanate react with air moisture. Even if the polyurethane reaction is not completed directly after the manufacturing process, the processing can be immediately carried out, since the (meth)acrylate component has been polymerized and thus forms a supporting frame in which the isocyanate is incorporated and, as described above, is slowly converted to polyurethane.

Thus, the present invention relates to such a building board at which the isocyanate in the adhesion layer is completely converted to polyurethane and relates also to a multi layered board, which is suitable for the manufacturing of such a building board at which the adhesion layer (yet) consists of a mixture of isocyanate and (meth)acrylate. Such a board is, so to speak, the precursor for the layered building board of the invention.

In a preferable embodiment, a décor layer is applied between the adhesion layer and the preferably thereon applied (meth)acrylate layer. The décor layer is preferably printed by means of direct printing on the partially cured adhesion layer and therefore consists of the décor color itself. In other words, the décor layer is preferably not formed by a décor paper, as it is usually the case for commercially available laminate boards, but it is preferably directly printed by means of digital printing on the partially cured adhesion layer.

In particular and preferably, a polymerizable décor color is used as décor color. Such polymerizable décor colors improve the mechanical characteristics of the layered board. It is assumed that, due to the polymerizing reaction of the décor layer at least in the border regions, a chemical reaction with the (meth)acrylate compounds of the adhesion layer and the (meth)acrylate layer that is applied later thereon occurs, which is responsible for an improved adhesion of the different layers.

The adhesion layer preferably consists of a combination of at least one (meth)acrylate, at least one trimeric polyisocyanate, at least one photoinitiator and, where required, one or more additives for the improvement of the application characteristics, like for instance formulation additives or condensation resins.

The (meth)acrylate component is generally preferred a mono-functional alkyl(meth)acrylate that comprises a glassing temperature of not more than 0° C. The alkyl(meth)acrylate preferably is a (meth)acrylic acid ester of alkanols that comprise 2 to 12 carbon atoms. In particular and preferably, the alkyl(meth)acrylates comprise a boiling point at normal pressure of at least 140° C., and most preferably of at least 200° C. This results in a low fugacity of the alkyl(meth)acrylates. Most preferably the component is selected from the group consisting of ethyl acrylate, propyl acrylate, n-butyl acrylate, n-hexyl acrylate, n-octyl acrylate, 2-ethyl-hexyl acrylate, 3-propyl-heptyl acrylate, n-decyl acrylate, lauryl acrylate, n-pentyl methacrylate, n-octyl methacrylate, n-decyl methacrylate and lauryl methacrylate, butyl(meth)acrylate, 2-ethyl-hexyl acrylate or 3-propyl-heptyl acrylate.

The polyisocyanate compound consists of generally preferably aliphatic or cycloaliphatic compounds, which are designated herein for short as (cyclo)aliphatic. Preferred are di- and poly-isocyanates with a NCO functionality of at least 1.8, more preferred of 1.8 to 5 and in particular preferred 2 to 4, as well as their isocyanurates, biurets, allophanates and uretdiones, which can be obtained from these underlying diisocyanates in a monomeric form by oligomerization. The content of isocyanate groups, calculated as NCO=42 g/mol is generally from 5 to 25 wt % of the oligomeric isocyanate.

The diisocyanates are preferably isocyanates with 4 to 20 C-atoms. Examples for usual diisocyanates are aliphatic diisocyanates like tetramethylene diisocyanate, 1,6-hexamethylene diisocyanate (1,6-diisocyanatohexane), octamethylene diisocyanate, decamethylene diisocyanate, dodecamethylene diisocyanate, tetradecamethylene diisocyanate, derivatives of the lysine diisocyanate, tetramethylxylylene diisocyanate, trimethylhexane diisocyanate or tetramethylhexane diisocyanate, cycloaliphatic diisocyanates like 1,4-, 1,3- or 1,2-diisocyanatocyclohexane, 4,4′- or 2,4′-di(isocyanatocyclohexyl)methane, 1-isocyanato-3,3,5- trimethyl-5-(iso-cyanatomethyl)cyclohexane (isophorone diisocyanate), 1,3- or 1,4-bis(isocyanatomethyl)cyclohexane or 2,4-, or 2,6-diisocyanato-1-methylcyclohexane.

There may also be mixtures of the mentioned diisocyanates. Preferred are hexamethylene diisocyanate, 1,3-bis(isocyanatomethyl)cyclohexane, isophoronedi-isocyanate and di(isocyanatocyclohexyl)methane, and most preferred is hexamethylene diisocyanate.

As polyisocyanates, polyisocyanates comprising isocyanurate groups, uretdione diisocyanates, polyisocyanates comprising biuret groups, polyisocyanates comprising urethane or allophanate groups, polyisocyanates comprising oxadiazintrione groups, uretonimine-modified polyisocyanates of aliphatic diisocyanates with a total of 6 to 20 C-atoms and/or cycloaliphatic diisocyanates with a total of 6 to 20 C-atoms can be considered.

The insertable di- and polyisocyanates preferably have a content of isocyanate groups (calculated as NCO, molecular weight =42) of 10 to 60 wt % relating to the di- and polyisocyanate (mixture), preferably 15 to 60 wt % and most preferred between 20 to 55 wt %. Preferred are aliphatic, respectively cycloaliphatic di- and polyisocyanates, for instance the previously mentioned aliphatic respectively cycloaliphatic diisocyanates or mixtures thereof.

Furthermore, generally preferred are:

1) Polyisocyanates of aliphatic and/or cycloaliphatic diisocyanates comprising isocyanurate groups. In particular and preferred are here the corresponding aliphatic or cycloaliphatic isocyanato-isocyanurates and in particular the ones on the base of hexamethylene diisocyanate and isophorone diisocyanate. The present isocyanurates are thereby in particular tris-isocyanatoalkyl-, respectively tris-isocyanato-cycloalkyl-isocyanurates, which represent cyclic trimers of the diisocyanates, or are mixtures with their higher homologues, that comprise more than one isocyanurate ring. The isocyanato-isocyanurates generally have a NCO content of 10 to 30 wt %, in particular 15 to 25 wt % and a mean NCO functionality of 3 to 4.5.

2) Uretdione diisocyanates with aliphatic and/or cycloaliphatic bonded isocyanate groups, preferably aliphatic or cycloaliphatic bonded and in particular the ones derived from hexamethylene diisocyanate or isophorone diisocyanate. The uretdione diisocyanates are cyclic dimerization products of diisocyanates. The uretdione diisocyanates can be used in the preparation as sole components or as a mixture with other polyisocyanates, in particular the ones mentioned in 1).

3) Polyisocyanates comprising biuret groups with cycloaliphatic or aliphatic bonded isocyanate groups, in particular tris(6-isocyanatohexyl)biuret or mixtures thereof with its higher homologues. These polyisocyanates comprising biuret groups generally comprise a NCO content of 18 to 25 wt % and a mean NCO functionality of 3 to 4.5.

4) Polyisocyanates comprising urethane- and/or allophanate groups with aliphatic or cycloaliphatic bonded isocyanate groups, like they can be obtained for instance by the conversion of surplus amounts of hexamethylene diisocyanate or of isophorone diisocyanate with polyhydric alcohols, like for instance trimethylolpropane, neopentylglycol, pentaerythrite, 1,4-butanediol, 1,6-hexanediol, 1,3-propanediol, ethyleneglycol, diethyleneglycol, glycerin, 1,2-dihydroxypropane or mixtures thereof, or preferred with at least one compound (C2), preferred 2-hydroxyethyl(meth)acrylate. These polyisocyanates comprising urethane and/or allophanate groups generally have a NCO content of 12 to 20 wt % and a mean NCO-functionality of at least 2, preferably at least 2.1 and particularly preferred between 2.5 to 3.

5) Polyisocyanates comprising oxadiazintrione groups, preferably derived from hexamethylene diisocyanates or isophorone diisocyanates. Such polyisocyanates which contain oxadiazintrione groups are producible from diisocyanate and carbon dioxide. However, the above mentioned content of oxadiazintrione groups is to be taken into account, where appropriate.

6) Uretonimine-modified polyisocyanates.

The polyisocyanates 1) to 6) can also be used as a mixture with diisocyanates, where appropriate.

Photoinitiators that are photoinitiators, which are known by the person skilled in the art can be used, for instance such as mentioned in “Advances in Polymer Science”, Volume 14, Springer Berlin 1974 or in K. K. Dietliker, Chemistry and Technology of UV- and EB-Formulation for Coatings, Inks and Paints, Volume 3; Photoinitiators for Free Radical and Cationic Polymerization, P. K. T. Oldring (Eds), SITA Technology Ltd, London. Considerable are for instance phosphine oxides, benzophenones, a-hydroxy-alkyl-aryl-ketones, thioxanthones, anthraquinones, acetophenones, benzoines and benzoinethers, ketals, imidazoles or phenylglyoxylic acids. Also considerable are photoinitiators, as described in WO 2006/005491 A1, page 21, line 18 to page 22, line 2.

The following compounds are mentioned exemplarily for the single classes:

Mono- or bis-acylphosphine oxides, like for instance Irgacure® 819 (bis(2,4,6-trimethylbenzoyl)phenyl-phosphine oxide), like they are described in EP-A 7 508, EP-A 57 474, DE-A 196 18 720, EP-A 495 751 or EP-A 615 980, for example 2,4,6-trimethylbenzoyldiphenylphosphine oxide (Lucirin® TPO), ethyl-2,4,6-trimethylbenzoylphenylphosphinate, bis(2,6-dimethoxybenzoyl)-2,4,4-trimethylpentylphosphine oxide, benzophenone, 4-aminobenzophenone, 4,4′-bis(dimethylamino)benzophenone, 4-phenylbenzophenone, 4-chlorobenzophenone, Michler's ketons, o-methoxybenzophenone, 2,4,6-trimethylbenzophenone, 4-methylbenzophenone, 2,4-dimethylbenzophenone, 4-isopropylbenzophenone, 2-chlorobenzophenone, ,2′-dichlorobenzophenone, 4-methoxybenzophenone, 4-propoxybenzophenone or 4-butoxybenzophenone, 1-benzoylcyclohexane-1-ol (1-hydroxy-cyclohexyl-phenylketone), 2-hydroxy-2,2-dimethylaceto-phenone (2-hydroxy-2-methyl-1-phenyl-propan-1-one), 1-hydroxyacetophenone, 1-[4-(2-hydroxy-ethoxy)-phenyl]-2-hydroxy-2-methyl-1-propan-1-one, polymeric, which contains polymerized 2-Hydroxy-2-methyl-1-(4-isopropen-2-yl-phenyl)-propan-1-one (Esacure® KIP 150), 10-thioxanthenone, thioxanthen-9-one, xanthen-9-one, 2,4-dimethylthioxanthone, 2,4-diethylthioxanthone, 2,4-di-iso-propylthioxanthone, 2,4-dichlorothioxanthone, chloroxanthenone, β-methylanthraquinone, tert-butylanthraquinone, anthraquinone carbonylic acid ester, benz[de]anthracene-7-one, benz[a]anthracen-7,12-dione, 2-methylanthraquinone, 2-ethylanthraquinone, 2-tert-butylanthraquinone, 1-chloroanthraquinone, 2-amylanthraquinone, acetophenone, acetonaphthoquinone, valerophenone, hexanophenone, α-phenylbutyrophenone, p-morpholinopropiophenone, dibenzosuberone, 4-morpholinobenzophenone, p-diacetylbenzole, 4′-methoxyacetophenone, α-tetralone, 9-acetylphenanthrene, 2-acetylphenanthrene, 3-acetylphenanthrene, 3-acetylindole, 9-fluorenone, 1-indanone, 1,3,4-triacetylbenzole, 1-acetonaphthone, 2-acetonaphthone, 2,2-dimethoxy-2-phenylacetophenone, 2,2-diethoxy-2-phenylacetophenone, 1,1-dichloroacetophenone, 1-hydroxyacetophenone, 2,2-diethoxyacetophenone, 2-methyl-1-[4-(methylthio)phenyl]-2-morpholinopropan-1-one, 2,2-dimethoxy-1,2-diphenylethan-2-one, 2-benzyl-2-dimethylamino-1-(4-morpholinophenyl)-butan-1-one, 4-morpholinodeoxybenzoine, benzoine, benzoin-iso-butylether, benzoin-tetrahydropyranylether, benzoin-methylether, benzoin-ethylether, benzoin-butylether, benzoin-iso-propylether, 7-H-benzoin-methylether, acetophenondimethylketal, 2,2-diethoxyacetophenone, benzilketals like benzildimethylketal, phenylglyoxalic acids as described in DE-A 198 26 712, DE-A 199 13 353 or WO 98/33761, for instance phenylglyoxalacidic mono- and -diesters of polyethylenglycoles with a molar mass of 62 to 500 g/mol. Also included are benzaldehyde, methylethylketone, 1-naphthaldehyde, triphenylphosphine, tri-o-tolylphosphine, and 2,3-butandione.

Mixtures to be mentioned are in particular 2-hydroxy-2-methyl-1-phenyl-propan-2-one and 1-hydroxy-cyclohexyl-phenylketone, bis(2,6-dimethoxybenzoyl)-2,4,4-trimethylpentylphosphinoxide and 2-hydroxy-2-methyl-1-phenyl-propan-1-one, benzophenone and 1-hydroxy-cyclohexyl-phenylketone, bis(2,6-dimethoxybenzoyl)-2,4,4-trimethylpentylphosphinoxide and 1-hydroxy-cyclohexyl-phenylketone, 2,4,6-trimethylbenzoyldiphenylphosphinoxide and 2-hydroxy-2-methyl-1-phenyl-propan-1-one, 2,4,6-trimethylbenzophenone and 4-methylbenzophenone, 2,4,6-trimethylbenzophenone and 4-methylbenzophenone and 2,4,6-trimethylbenzoyldiphenylphosphineoxide.

Possible photoinitiators are also polymeric photoinitiators, like for instance the diesters of carboxymethoxybenzophenone with polytetramethylenglycolenes of a different molecular weight, preferably 200 to 250 g/mol (CAS 515136-48-8), and CAS 1246194-73-9, CAS 813452-37-8, CAS 71512-90-8, CAS 886463-10-1 or further polymeric derivatives of benzophenone, as they are for instance commercially available under the trade names Omnipol® BP by the company IGM Resins B. V., Waalwijk, Netherlands or Genopol® BP1 by the company Rahn A G, Switzerland. Further considerable are also polymeric thioxanthones, for instance the diesters of carboxymethoxythioxanthones with polytetramethylenglycoles of a different molecular weight, like they are for instance commercially available under the trade name Omnipol® TX by the company IGM Resins B. V., Waalwijk, Netherlands. Further considerable are also polymeric a-amino-ketones, for instance the diesters of carboxyethoxythioxanthones with polyethylenglycoles of a different molecular weight like they are for instance commercially available under the trade names Omnipol® 910 or Omnipol® 9210 by the company IGM Resins B. V., Waalwijk, Netherlands.

For the improvement of the adhesion, as well as the application ability, for instance condensation resins built from urea or derivatives of urea and keton or aldehydes which are selected from C—H acidic aldehydes respectively ketons or mixtures thereof with formaldehyde can furthermore be applied. As formulation additives, customary lacquer formulation additives can be used, like for instance anti-foam agents, vents, dispersing additives, flow improver additives etc.

The core is preferably a relatively stiff board with a thickness of 2 to 50 mm, preferably of 3 to 50 mm and most preferred of 4 to 50 mm. As a starting point for the core, for instance laminate boards can be chosen, i.e. a board consisting of multiple paper layers impregnated with phenolic resin (also designated as High Pressure Laminate—HPL). Further preferred materials are medium density fiber boards (MDF) or high density fiber boards (HDF) but also wood based materials or PVC boards. In a completely formed adhesion layer, in which the isocyanate is thus completely reacted, the weight percentage of the polyurethane is preferably more than 5%, more preferred more than 20% and most preferred more than 40%.

In order to increase the UV resistance in a building board that is manufactured in such a way, additional additives can be added, for instance scavengers and UV absorbers as an atmospheric protection for outside applications or nanoparticle modified components for increasing the scratch and micro-scratch resistance. These additives are preferably added to the (meth)acrylate layer which is arranged on the adhesion layer.

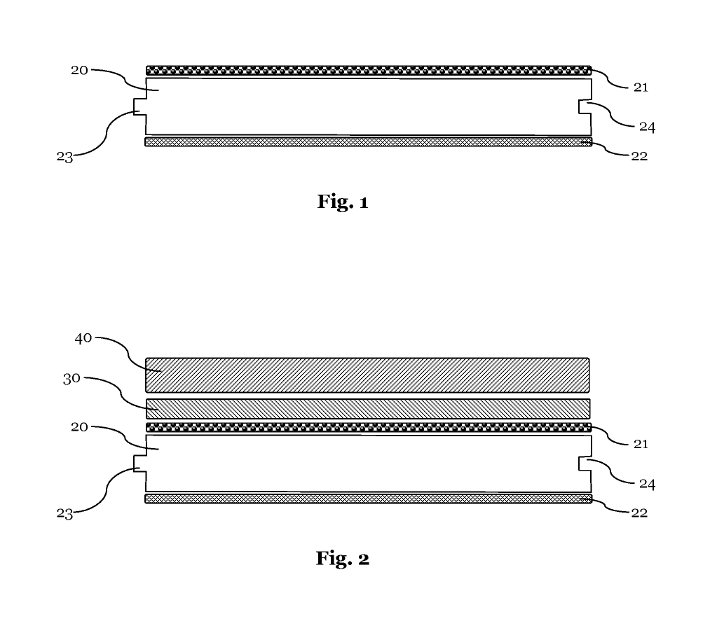

In FIG. 1 a schematic structure of the core 20 is shown. The core 20 comprises a front and a rear side, wherein a paper 21 impregnated with a thermoset resin, like for instance a melamine resin, and on the rear side a paper 22 also impregnated with a thermoset resin, is arranged. The core 20 may for instance be an MDF or HDF board.

In particular and preferred, the core 20 consists of a larger amount of Kraft papers impregnated with phenolic resin like about 20 to 90 layers of paper. The structure shown in FIG. 1 is pressed in the press under the influence of heat and pressure to one compound. The different resins in the core and the cover layers cure therein. In FIG. 2 a schematic structure of a layered board, according to the present invention, is exemplarily shown. The board of FIG. 2 comprises a core 20 and décor impregnates 22 and 21 of the embodiment of the FIG. 1. These layers are preferably pressed together before the adhesion layer (adhesion primer) 30 is applied on the paper 21. The adhesion layer 30 consists of a mixture of isocyanates and (meth)acrylates. A further acrylate layer is arranged on this adhesion layer. The adhesion layer has a generally preferred thickness (height) of 10 to 100 μm, more preferred of 10 to 80 μm, even more preferred of 15 to 70 μm and most preferred of 20 to 60 μm. These indications of thickness apply for the adhesion layer after curing. Also generally preferred has the thereon arranged additional acrylate layer 40 with a thickness (height) of more than 20 μm, more preferred of more than 30 μm and most preferred of more than 40 μm (after curing). Preferably, the thickness of the acrylate layer 40 should not be larger than 100 μm. The layered board, which is exemplarily shown in FIG. 2, can already be processed. The full adhesion of the single layers is however only reached after the isocyanate of the adhesion layer 30 has completely reacted with the (meth)acrylate groups under the formation of polyurethane. An almost complete conversion of the isocyanate is reached after about 10 days.

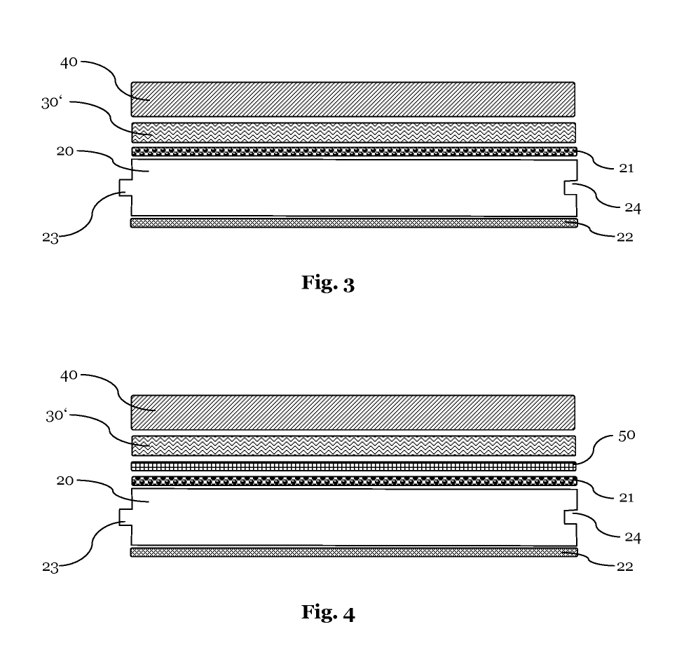

In FIG. 3, the layered board of FIG. 2 is shown after the complete conversion of the isocyanate. The pattern of the layer 30′ is different compared to the layer 30 in the figures, for illustrative purposes. The layer 30′ consists, as set out above, essentially of (meth)acrylates and polyurethane.

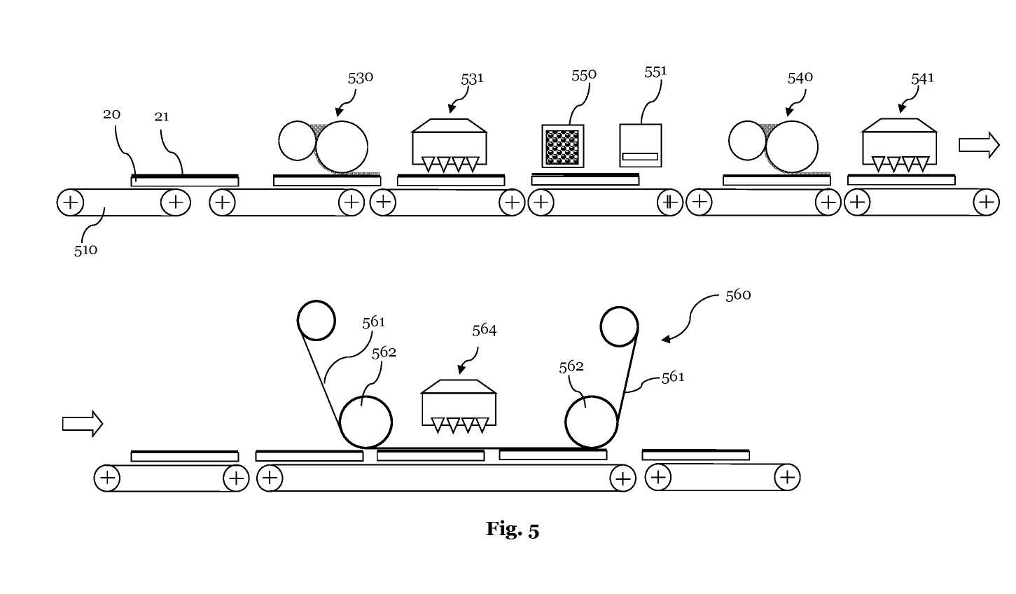

FIG. 4 shows a preferred embodiment also in a schematic view. In the embodiment of the FIG. 4 a décor layer 50 is arranged on a paper 21 impregnated with a thermoset resin, for instance a melamine resin and is arranged below the adhesion layer 30, respectively 30′. Since the used (meth)acrylates of both layers 30 and 40 are preferably transparent, it is thus possible to provide the building board with any desired décor.

In the shown embodiments, the layers are each located only on the front side of the core layer 20. However, a person skilled in the art should know that the same or a similar layer composition can also be provided additionally or alternatively on the rear side of the core.

In FIG. 5 a device or system is schematically shown to illustrate the method according to the invention. Starting point for the method is a core with a paper 21, which is impregnated with a thermoset resin, like for instance a melamine resin, wherein the melamine resin of the paper is already cured, for instance by a respective upstream pressing process (not shown). These precursors are guided through the different stations by means of a belt conveyor system 510. In the station 530 a liquid mixture of isocyanate and acrylate is applied. This mixture (adhesion layer 30) is gelled in station 531, i.e. the (meth)acrylate, which is contained by the mixture, only partially polymerized. The station 550 illustrates in the Figure a digital printing device with which a desired décor can be imprinted to the paper 21, respectively the adhesion layer 30. The papers 21 however may also already comprise any décor themselves, so that the printing step at 550 is not strictly necessary. Because of the flexibility, which is provided by a direct printing of the boards, a direct printing by means of a printing station 550 is however preferred. The printing color applied at 550 is pre-dried at 551. Another (meth)acrylate layer 40 is then applied to the partially cured layer at station 540 and both of the layers 30 and 40 are completely cured in station 541. After station 541, the board is ready for further processing. However, it should be preferably waited for approximately 10 days with further processing, until the isocyanate is completely converted. In FIG. 5, another station 560 follows to the station 541. The station 560 serves to provide a structure to the top most (meth)acrylate layer 40. If such a structure is desired, the station 541 is not put into service, i.e. the acrylate layer 40, which is applied at station 540, is not cured in station 541. Instead of that, a curing station 564 is provided in station 560. With the reference number 561 a structuring foil is designated, which is guided over guide rollers 562 and brought into contact with the front side of the boards. The structuring foil 561 contains a negative relief of the structure to be applied and presses said structure into the yet wet acrylate layer 40. The curing station 564 works for instance with UV radiation and irradiates through the structuring foil 561, which is permeable for UV radiation for this purpose. At the end of the station 560 the structuring foil 561 is removed from the surface of the now completely cured boards, so that a structure, like for instance a three-dimensional wood structure, is provided in the surface of the boards.

### EXAMPLES

The invention will be further specified in the following examples:

### Manufacturing of the Building Board

Soda-Kraft paper comprising a grammage of 150 g/m² is impregnated with a commercially available phenolic resin suitable for compact boards. The impregnate has a mass per unit area of 220 g/m² after the impregnation. A white décor paper with a grammage of 95 g/m² is impregnated with a commercially available melamine resin; the mass per unit area of this impregnated décor paper is 214 g/m². In the laying station, the following combination of the impregnated webs occur: décor sheet/75 layers of phenolic resin impregnate/décor sheet (from bottom to top). The so combined layers are conveyed to a multi-platen press and pressed as follows: a) pressure build up to a specific pressing pressure of 8 MPa, b) heating up within 8 mins up to 140° C., c) remaining temperature at 140° C. for 20 mins, d) cooling down to room temperature within 8 mins, e) conditioning at room temperature for 5 mins and f) reducing pressure to normal pressure and demolding from the press.

### Example A

The building board manufactured in that way is provided with an adhesion layer (adhesion primer) according to the invention in a roll applicator in an application quantity of 15 g/m². The adhesion layer consists of 35 wt. parts of Laromer LR9085, 10 wt. parts of propylheptylacrylate, 2.5 wt. parts of laurylacrylate, 0.5 wt. parts of EFKA3777, 0.2 parts of TegoRad2011, 1.8 wt. parts of Irgacure MBF as well as 50 parts of Basonate HI 100. These are commercially available materials. The adhesion layer is gelled by means of UV radiation. In a further method step, an additional acrylate layer is applied as top layer (top lacquer) by means of a roll applicator with an application quantity of 35 g/m². The top layer consists of the following: 60.3 wt. parts of Laromer LR 8987, 22.2 wt. parts of Laromer HDDA, 2 wt. parts of Tinuvin 400, 1 wt. part of Tinuvin 292, 10 wt. parts of ethylhexylacrylate, 2 wt. parts of Irgacure TPO-L, 2 wt. parts Irgacure of 184 and 0.2 wt. parts of TegoRad 2010. The applied top layer is cured by means of UV radiation.

### Example B

The building board is coated with the adhesion layer from example A by means of a roll applicator in an amount of 10 g/m² and the applied adhesion primer is gelled by means of UV radiation. Upon this layer a décor layer, in this case an oak imitation, is produced by means of an industrial digital printer. Thereby 4.5 g/m² digital printing ink is applied, which is split up to the colors yellow, magenta, cyan and black. These colors are polymerizable and are gelled by means of UV radiation. In the next working step the top lacquer from example A is applied by means of a roll applicator in an amount of 30 g/m². This layer is conveyed in “wet condition” to a foil calender. A second layer of the top lacquer is rolled on a structuring foil, in this case a reproduction of an oak structure, namely 25 g/m². Both “wet” layers are merged in the foil calender. The complete layer is irradiated through the foil by means of UV radiation and thereby inertly cured. After withdrawing of the foil, a decorative compact board is obtained, in this case an oak imitation with appropriate pore structure.

The building boards manufactured in examples A and B are subjected to a laboratory test after 10 days of storage. All parameters required according to EN 438 are thereby safely achieved. In addition, the board fulfils the requirements for the highest level of micro scratch resistance, according to EN 16094.

Many other benefits will no doubt become apparent from future application and development of this technology.

All patents, applications, standards, and articles noted herein are hereby incorporated by reference in their entirety.

The present subject matter includes all operable combinations of features and aspects described herein. Thus, for example if one feature is described in association with an embodiment and another feature is described in association with another embodiment, it will be understood that the present subject matter includes embodiments having a combination of these features.

As described hereinabove, the present subject matter solves many problems associated with previous strategies, systems and/or devices. However, it will be appreciated that various changes in the details, materials and arrangements of components, which have been herein described and illustrated in order to explain the nature of the present subject matter, may be made by those skilled in the art without departing from the principle and scope of the claimed subject matter, as expressed in the appended claims.

What is claimed is:

1. A layered building board for inside and outside comprising:
a core with a front side and a rear side;
an amino resin impregnated paper arranged thereon;
an adhesion layer comprising polyurethane and acrylate arranged on the paper.

2. The layered building board according to claim 1, further comprising:
an acrylate layer arranged on the adhesion layer, wherein the acrylate layer has a thickness of more than 20 μm.

3. The layered building board according to claim 1, wherein the adhesion layer has a thickness of 10 to 100μm.

4. The layered building board according to claim 1, wherein the adhesion layer consists essentially of polyurethane and acrylate.

5. The layered building board according to claim 2 further comprising:
a décor layer consisting of a décor color arranged between the adhesion layer and the acrylate layer.

6. The layered building board according to claim 5, wherein the décor color is a polymerizable décor color.

7. The layered building board according to claim 1 wherein the core has a thickness of 2 to 80 mm.

8. The layered building board according to claim 1 wherein the core is selected from the group consisting of a laminate board, MDF-board, HDF-board, wood based material board, and PVC-board.

9. The layered building board according to claim 1 wherein the adhesion layer consists essentially of polyurethane and acrylate and wherein the polyurethane has a weight percentage of more than 5%.

10. A layered board for manufacturing a building board comprising:
a core with a front side and a rear side;
an amino resin impregnated paper arranged thereon;
an adhesion layer of a mixture of isocyanate and (meth)acrylate arranged on the paper; and
an acrylate layer arranged thereon.

11. The layered board according to claim 10, wherein the acrylate layer, which is arranged on the adhesion layer, has a thickness of more than 20 μm.

12. The layered board, according to claim 10, wherein the adhesion layer has a thickness of 10 to 100 μm.

13. The layered board according to claim 10, wherein the adhesion layer consists essentially of isocyanate and (meth)acrylate.

14. The layered board according to claim 10, further comprising a décor layer consisting of décor color provided between the adhesion layer and the acrylate layer.

15. The layered board according to claim 14, wherein the décor layer includes a polymerizable décor color.

16. The layered board according to claim 10, wherein the (meth)acrylate of the adhesion layer is based on (meth)acrylic acid ester of alkanols that comprise 2 to 12 carbon atoms.

17. The layered board according to claim 10, wherein the (meth)acrylate of the adhesion layer is selected from the group consisting of ethylacrylate, propylacrylate, n-butylacrylate, n-hexylacrylate, n-octylacrylate, 2-ethylhexylacrylate, 3-propylheptylacrylate, n-decylacrylate, laurylacrylate, n-pentylmethacrylate, n-octylmethacrylate, n-decylmethacrylate and laurymethacrylate, butyl(meth)acrylate, 2-ethylhexylacrylate, and 3-propylheptylacrylate and combinations thereof.

18. The layered board according to claim 10, wherein the isocyanate is based on di- and/or polyisocyanates with a NCO functionality of at least 1.8.

19. The layered board according to claim 18, wherein the di-isocyanates are isocyanates with 4 to 20 C-atoms.

20. The layered board according to claim 18, wherein the polyisocyanates are selected from the group consisting of polyisocyanates comprising isocyanurate groups, uretdione diisocyanates, polyisocyanates comprising biuret groups, polyisocyanates comprising urethane or allophanate groups, polyisocyanates comprising oxadiazintrione groups, uretonimine-modified polyisocyanates of aliphatic diisocyanates with a total of 6 to 20 C-atoms, cycloaliphatic diisocyanates with a total of 6 to 20 C-atoms, and combinations thereof.

21. The layered board, according to claim 10, wherein the core layer is selected from the group consisting of a laminate board, MDF-board, HDF-board, wood based material board, and PVC-board.

22. A method for manufacturing a layered building board for inside and outside comprising the following steps:
a. providing a core with a front side and a rear side;
b. providing an amino resin impregnated paper on the front and/or rear side;
c. providing a mixture of isocyanate and (meth)acrylate on the paper thereafter;
d. applying an acrylate layer after step c; and
e. applying the layers applied in step c. and d., together.

23. The method for manufacturing a layered building board according to claim 22, whereby the mixture of isocyanate and (meth)acrylate is partially cured after step c. and before step d.

24. The method for manufacturing a layered building board according to claim 23, whereby a décor layer is directly printed on a layer comprising the mixture of isocyanate and (meth)acrylate after the partial curing and before step d.

25. The method for manufacturing a layered building board according to claim 22, whereby the mixture of isocyanate and (meth)acrylate is applied by applicator rollers.

26. The method for manufacturing a layered building board according to claim 22, whereby the applied acrylate layer is provided with a structure after step d. and before step e.

27. The method for manufacturing a layered building board according to claim 22, whereby the acrylate layer applied in step d. has a thickness of more than 20 μm.

28. The method for manufacturing a layered building board according to claim 22, whereby providing the mixture of isocyanate and (meth)acrylate on the paper forms on adhesion layer and the adhesion layer has a thickness of 10 to 100 μm.

29. The method for manufacturing a layered building board according to claim 24, whereby the décor layer includes a polymerizable décor color.

30. The method for manufacturing a layered building board according to claim 22, whereby the core has a thickness of 2 to 50 mm.

31. The method for manufacturing a layered building board according to claim 22, whereby the core is selected from the group consisting of a laminate board, MDF-board, HDF-board, wood based material board, and PVC-board.
